(19) United States
(12) Patent Application Publication
(10) Pub. No.: US 2013/0182469 A1
(43) Pub. Date: Jul. 18, 2013

(54) ELECTRO-MAGNETIC INTERFERENCE REDUCTION CIRCUIT FOR POWER CONVERTERS AND METHOD FOR THE SAME

(71) Applicant: Ting-Ta CHIANG, Dalin Township (TW)

(72) Inventor: Ting-Ta CHIANG, Dalin Township (TW)

(73) Assignee: SYSTEM GENERAL CORPORATION, New Taipei City (TW)

(21) Appl. No.: 13/351,117

(22) Filed: Jan. 16, 2012

(51) Int. Cl. H02M 1/12

(52) U.S. Cl. 363/44

(57) ABSTRACT

The present invention provides a circuit of reducing electro-magnetic interference for a power converter. The circuit includes an oscillator, a current generation circuit, a feedback circuit and a ramping generator. The oscillator has a first terminal for receiving a first jittering current and a second terminal for feeding a second jittering current. The first jittering current and the second jittering current are correlated with a line signal obtained from an input of the power converter to vary a frequency of the oscillator. The first jittering current and the second jittering current are unequal. As the first jittering current is set greater than the second jittering current, the frequency of the switching signal increases whenever the line signal is increasing. As the first jittering current is set lower than the second jittering current, the frequency of the switching signal decreases whenever the line signal is increasing.

### BACKGROUND OF THE INVENTION

1. Field of the Invention

The present invention relates to switching power supplies, and more specifically to an Electro-Magnetic Interference (EMI) reduction circuit for power converters.

2. Description of the Related Art

FIG. 1A shows a schematic of a power converter, which is a PFC (power factor correction) power converter. The power converter as shown in FIG. 1A comprises an EMI filter 5, a bridge rectifier 10, an inductor 11, a power switch 13, a rectifier 12, a bulk capacitor 14, a controller 90, a line resistor 15, and a voltage divider formed by resistors 16 and 17. The operation of the PFC power converter shown in FIG. 1A is well known to those skilled in the art and will be omitted herein.

In order to meet regulations, such as FCC emission standards for electro-magnetic interference (EMI), the EMI filter 5 is equipped between an alternating current (AC) mains V_{AC} and the bridge rectifier 10. However, the EMI filter 5 occupies significant layout space and increases component costs to power converters. Some prior arts had proposed solutions to eliminate the need of the EMI filter 5, such as U.S. Pat. No. 7,203,079 titled “Switching Controller Having Frequency Hopping for Power Supplies” and U.S. Pat. No. 7,391,628 titled “Switching Controller Having Frequency Hopping for Power Supplies and Method Therefore”. The aforementioned prior arts have more complex circuit design of frequency jittering, which occupies larger space on the controller chip and increases the manufacturing cost. Therefore, a cost-effective frequency jittering circuit with simple design is desired by the industry.

### BRIEF SUMMARY OF THE INVENTION

The present invention provides a circuit of reducing electro-magnetic interference for a power converter. The circuit comprises an oscillator, a current generation circuit, a feedback circuit and a ramping generator. The oscillator has a first terminal for receiving a first jittering current and a second terminal for feeding a second jittering current. The first jittering current and the second jittering current are correlated with a line signal obtained from an input of the power converter to vary a frequency of the oscillator. The current generation circuit generates the first jittering current and the second jittering current in response to the line signal. The feedback circuit receives a feedback signal from an output of the power converter. The feedback circuit further generates an error signal. The ramping generator generates a ramping signal to be compared with the error signal to disable a switching signal of the circuit. The ramping generator receives the switching signal to generate the ramping signal. As the first jittering current is set greater than the second jittering current, a frequency of the switching signal increases whenever the line signal is increasing. As the first jittering current is set lower than the second jittering current, a frequency of the switching signal decreases whenever the line signal is increasing. The first jittering current and the second jittering current are unequal.

The present invention also provides a method of reducing electro-magnetic interference for a power converter. The method comprises the steps of: generating a first jittering current in response to a line signal obtained from an input of the power converter with a first ratio; generating a second jittering current in response to said line signal obtained from the input of the power converter with a second ratio; providing the first jittering current and the second jittering current to an oscillator of the power converter; receiving a feedback signal from an output of the power converter to generate an error signal; comparing a ramping signal from a ramping generator with the error signal to disable the switching signal; and receiving a pulse signal to enable the switching signal, wherein the pulse signal is generated from the oscillator. The oscillator determines a frequency of a switching signal for the power converter according to said first jittering current and said second jittering current. Two jittering modes are selectable by adjusting the first ratio and the second ratio for spreading a frequency spectrum of a frequency of the switching signal. The ramping signal is generated in response to the switching signal. The first ratio and the second ratio are unequal.

It is an objective of the present invention to provide a circuit and a method for reducing electro-magnetic interference for a power converter by spreading a spectrum of a switching frequency.

It is another objective of the present invention to provide a circuit spreading a frequency spectrum of a switching signal using a waveform of a line signal obtained from an input of a power converter, which eliminates the need of an additional jittering signal generator and therefore simplifies the circuit design and saves the manufacturing cost.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A shows a traditional PFC power converter.

FIG. 1B shows an exemplary embodiment of a PFC power converter according to the present invention.

FIG. 2 shows an exemplary embodiment of a controller of the PFC power converter shown in FIG. 1B according to the present invention.

FIG. 3 shows an exemplary embodiment of an oscillator of the controller shown in FIG. 2 according to the present invention.

FIG. 4A shows waveforms of a saw-tooth signal, a pulse signal and an inverse signal shown in FIG. 3 according to the present invention.

FIG. 4B shows waveforms of a saw-tooth signal of the oscillator shown in FIG. 3 when a first jittering current is greater than a second jittering current.

FIG. 4C shows waveforms of the saw-tooth signal of the oscillator shown in FIG. 3 when the first jittering current is lower than the second jittering current.

FIG. 5A shows key waveforms of the PFC power converter shown in FIG. 1B under a first jittering mode.

FIG. 5B shows key waveforms of the PFC power converter shown in FIG. 1B under a second jittering mode.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

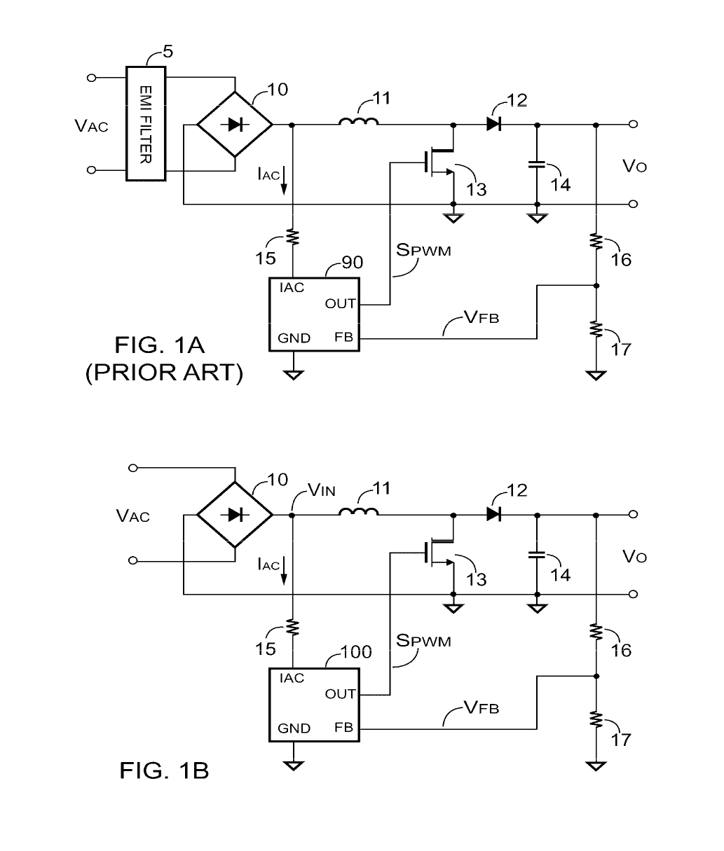

FIG. 1B shows an exemplary embodiment of a PFC power converter according to the present invention. Some other power factor correction operating descriptions of the PFC power converter are omitted hereinafter since they are well known to those skilled in the art and are out of the scope of the present invention. The PFC power converter as shown in FIG. 1B comprises a bridge rectifier 10, an inductor 11, a power switch 13, a rectifier 12, a bulk capacitor 14, a controller 100, a line resistor 15, and a voltage divider formed by resistors 16 and 17. Compared to the power converter shown in FIG. 1A, the EMI filter 5 is not included in this embodiment. The EMI is now reduced by the frequency jittering operation provided by the controller 100. Following descriptions will introduce a simple design for frequency jittering operation to save the manufacturing cost according to the present invention.

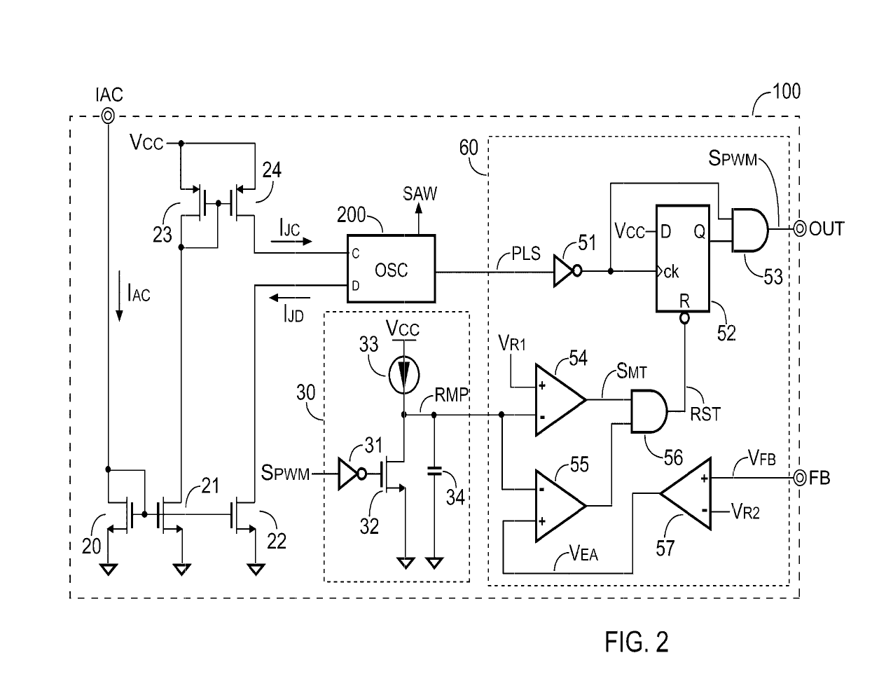

FIG. 2 shows an exemplary embodiment of the controller 100 according to the present invention. The controller 100 comprises a current generation circuit, a ramping generator 30, an oscillator (OSC) 200 and a switching circuit 60. In an exemplary embodiment, the current generation circuit is a current mirror which comprises transistors 20, 21, 22, 23 and 24. A drain of the transistor 20 receives a line signal I_{AC} obtained from an output voltage V_{IN} of the bridge rectifier 10 via the line resistor 15. A drain of the transistor 24 generates a first jittering current I_{JP}. A drain of the transistor 22 draws a second jittering current I_{JD}. The oscillator 200 receives the first jittering current I_{JC} at a charging terminal C and the second jittering current I_{JD} at a discharging terminal D to generate a saw-tooth signal SAW and a pulse signal PLS.

The transistors 20, 21, 23 and 24 are coupled to determine a first ratio for generating the first jittering current I_{JP}. The transistors 20, 21 and 22 are coupled to determine a second ratio for generating the second jittering current I_{JD}. The ramping generator 30 comprises an inverter 31, a current source 33, a transistor 32 and a capacitor 34. The transistor 32 is controlled by a switching signal S_{PWM} via the inverter 31. As the switching signal S_{PWM} is enabled, the current source 33 will start to charge the capacitor 34. As the switching signal S_{PWM} is disabled, the capacitor 34 will be discharged. A ramping signal RMP across the capacitor 34 is therefore generated in response to the switching signal S_{PWM}.

The switching circuit 60 comprises an inverter 51, a flip-flop 52, an AND gate 53, a comparator 54 and a feedback circuit. The feedback circuit comprises a comparator 55, an AND gate 56 and an error amplifier 57. The pulse signal PLS is supplied to a clock-input ck of the flip-flop 52 via the inverter 51. A D-input of the flip-flop 52 is supplied with a supply voltage V_{CC}. One input of the AND gate 53 is coupled to an output of the inverter 51. The other input of the AND gate 53 is coupled to an output Q of the flip-flop 52. An output of the AND gate 53 generates the switching signal S_{PWM}. The ramping signal RMP is supplied to negative terminals of the comparators 54 and 55. A positive terminal of the comparator 54 is supplied with a first reference voltage V_{R1}. The comparator 54 compares the ramping signal RMP with the first reference voltage V_{R1} to generate a maximum-duty signal S_{MT}. The maximum-duty signal S_{MT} is supplied to an input of the AND gate 56. A feedback signal V_{FB} and a second reference voltage V_{R2} are respectively supplied to a positive terminal and a negative terminal of the error amplifier 57. The feedback signal V_{FB} is obtained at the joint of the resistors 16 and 17, which is correlated with an output voltage V_{O} at an output of the PFC power converter. The error amplifier 57 amplifies the difference of the feedback signal V_{FB} and the second reference voltage V_{R2} to generate an error signal V_{EA}. The error signal V_{EA} is supplied to a positive terminal of the comparator 55. The comparator 55 provide an output signal to the other input of the AND gate 56 by comparing the ramping signal RMP and the error signal V_{EA}. An output of the AND gate 56 generates a reset signal RST to disable the switching signal S_{PWM} via the flip-flop 52 whenever the level of the maximum-duty signal S_{MT} or the output of the comparator 55 becomes logic-low.

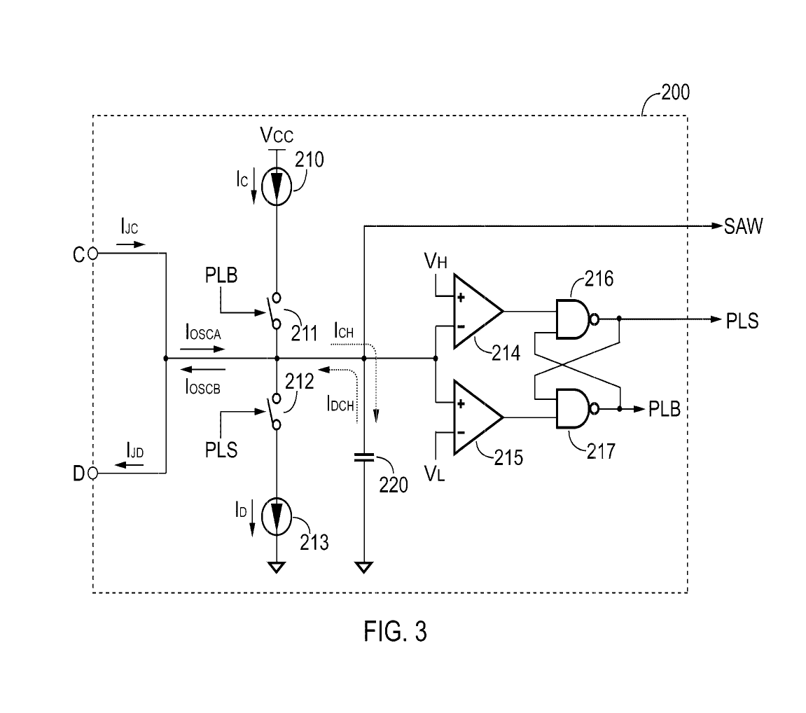

FIG. 3 shows an exemplary embodiment of the oscillator 200 of the controller 100 according to the present invention. The oscillator 200 comprises current sources 210 and 213, switches 211 and 212, comparators 214 and 215, NAND gates 216 and 217 and a capacitor 220. The current source 210 generating a current I_{C} is connected between the supply voltage V_{CC} and a first terminal of the switch 211. A second terminal of the switch 211 is connected to a first terminal of the switch 212. The current source 213 generating a current I_{D} is connected between a second terminal of the switch 212 and a ground reference. The capacitor 220 is connected between the second terminal of the switch 211 and the ground reference. The second terminal of the switch 211 is further coupled to a negative terminal of the comparator 214 and a positive terminal of the comparator 215. A positive terminal of the comparator 214 receives an upper-threshold V_{H}, and a negative terminal of the comparator 215 receives a lower-threshold V_{L}. The NAND gates 216 and 217 form a latch circuit which receives the outputs of the comparator 214 and 215. The NAND gate 216 generates the pulse signal PLS, and the NAND gate 217 generates an inverse pulse signal PLB. The switch 211 is controlled by the inverse pulse signal PLB. The switch 212 is controlled by the pulse signal PLS. A charging current I_{CH} and a discharging current I_{DCH} are applied to the capacitor 220 to generate the saw-tooth signal SAW across the capacitor 220.

The charging terminal C and the discharging terminal D are connected to a joint of the switches 211 and 212. When the first jittering current I_{JC} flowing via the charging terminal C is set to be greater than the second jittering current I_{JD} flowing via the discharging terminal D, an oscillation current I_{OSCA} will flow inward the joint of the switches 211 and 212, which exhibits a first jittering mode. On the contrary, when the first jittering current I_{JC} is set to be lower than the second jittering current I_{JD}, an oscillation current I_{OSCB} will flow outward the joint of the switches 211 and 212, which exhibits a second jittering mode. Since the first jittering current I_{JC} and the second jittering current I_{JD} are correlated with the line signal I_{AC}, the oscillation currents I_{OSCA} and I_{OSCB} are correlated with the line signal I_{AC} as well. The oscillation current I_{OSCA} associates with currents I_{C} and I_{D} to respectively generate the charging current I_{CH} and the discharging current I_{DCH} under the first jittering mode. The oscillation current I_{OSCB} associates with currents I_{C} and I_{D} to respectively generate the charging current I_{CH} and the discharging current I_{DCH} under the second jittering mode.

Once the first jittering current I_{JC} is set to be equal to the second jittering current I_{JD}, either the oscillation current I_{OSCA} or the oscillation current I_{OSCB} will be unavailable. In the meantime, the charging current I_{CH} to the capacitor 220 will be equal to the current I_{C} as the switch 211 is turned on by the inverse pulse signal PLB. The discharging current I_{DCH} to the capacitor 220 will be equal to the current I_{D} as the switch 212 is turned on by the pulse signal PLS. As a result, the frequency of the pulse signal PLS will be only determined by currents I_{C} and I_{D} and will be not correlated with the line signal I_{AC}. That is, the frequency jittering operation will be unavailable whenever the first jittering current I_{JC} is set to be equal to the second jittering current I_{JD}.

In the condition that the first jittering current I_{JC} and the second jittering current I_{JD} are unequal, when the inverse pulse signal PLB is enabled to turn on the switch 211, the charging current I_{CH} comprising the components of the current I_{C} and the oscillation currents I_{OSCA} or I_{OSCB} will start to charge the capacitor 220. When the pulse signal PLS is enabled to turn on the switch 212, a discharging current I_{DCH} comprising the components of the current I_{D} and the oscillation currents I_{OSCA} or I_{OSCB} will start to discharge the capacitor 220. The frequency of the pulse signal PLS will be determined by the charging current I_{CH} and the discharging current I_{DCH} to the capacitor 220. In order to vary the frequency of the pulse signal PLS to vary the frequency of the switching signal S_{PWM}, setting the first ratio and the second ratio unequal allows a frequency jittering operation to the pulse signal PLS and the switching signal S_{PWM}.

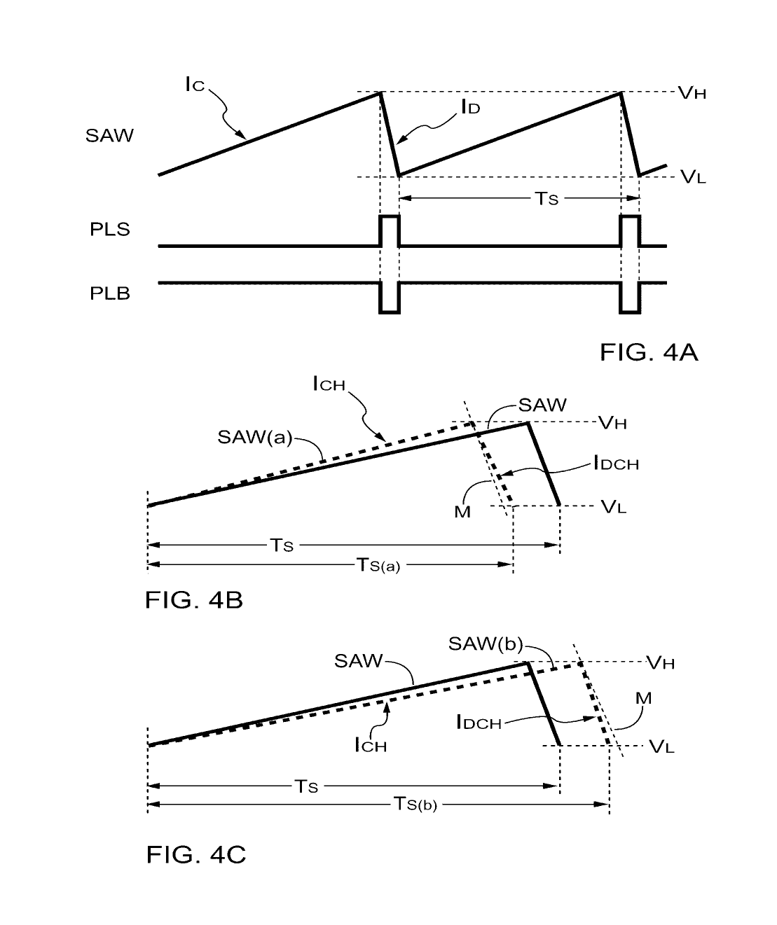

FIG. 4A shows the waveforms of the saw-tooth signal SAW, the pulse signal PLS and the inverse pulse signal PLB when the oscillation current I_{OSCA} or I_{OSCB} is unavailable. The pulse signal PLS and the inverse pulse signal PLB are complementary in phase. As the inverse pulse signal PLB is enabled, the charging current I_{CH} will be equal to the current I_{C} provided by the current source 210, which determines a charging slope of the saw-tooth signal SAW. As the pulse signal PLS is enabled, the discharging current I_{DCH} will be equal to the current I_{D} provided by the current source 213, which determines a discharging slope of the saw-tooth signal SAW. The magnitude of the current I_{D} is much greater than that of the current I_{C}. A switching period T_{S} of the saw-tooth signal SAW is the sum of the enabled periods of the pulse signal PLS and the inverse pulse signal PLB.

FIG. 4B shows the waveform of the saw-tooth signal SAW(a) of the oscillator 200 when the first jittering current I_{JC} is greater than the second jittering current I_{JD}. The saw-tooth signal SAW depicted in solid line is as shown in FIG. 4A. Both referring to FIG. 3 and FIG. 4B, the saw-tooth signal SAW(a) depicted in dotted line represents the saw-tooth signal SAW when the oscillation current I_{OSCA} flows inward the joint of the switches 211 and 212. This will increase the slope of the charging current I_{CH} and decrease the slope of the discharging current I_{DCH}. Therefore, the switching period T_{S} will be decreased to a shorter period T_{S(a)}. Line M represents the discharging slope of the saw-tooth signal SAW when the oscillation current I_{OSCA} is unavailable. The discharging slope of the saw-tooth signal SAW(a) is less than that of the saw-tooth signal SAW.

FIG. 4C shows the waveform of the saw-tooth signal SAW(b) of the oscillator 200 when the first jittering current I_{JC} is lower than the second jittering current I_{JD}. The saw-tooth signal SAW depicted in solid line is as shown in FIG. 4A. Both referring to FIG. 3 and FIG. 4C, the saw-tooth signal SAW(b) depicted in dotted line represents the saw-tooth signal SAW when the oscillation signal I_{OSCB} flows outward the joint of the switches 211 and 212. This will decrease the slope of the charging current I_{CH} and increase the slope of the discharging current I_{DCH}. Therefore, the switching period T_{S} will be increased to a longer period T_{S(b)}. Line M represents the discharging slope of the saw-tooth signal SAW when the oscillation current I_{OSCB} is unavailable. The discharging slope of the saw-tooth signal SAW(b) is greater than that of the saw-tooth signal SAW.

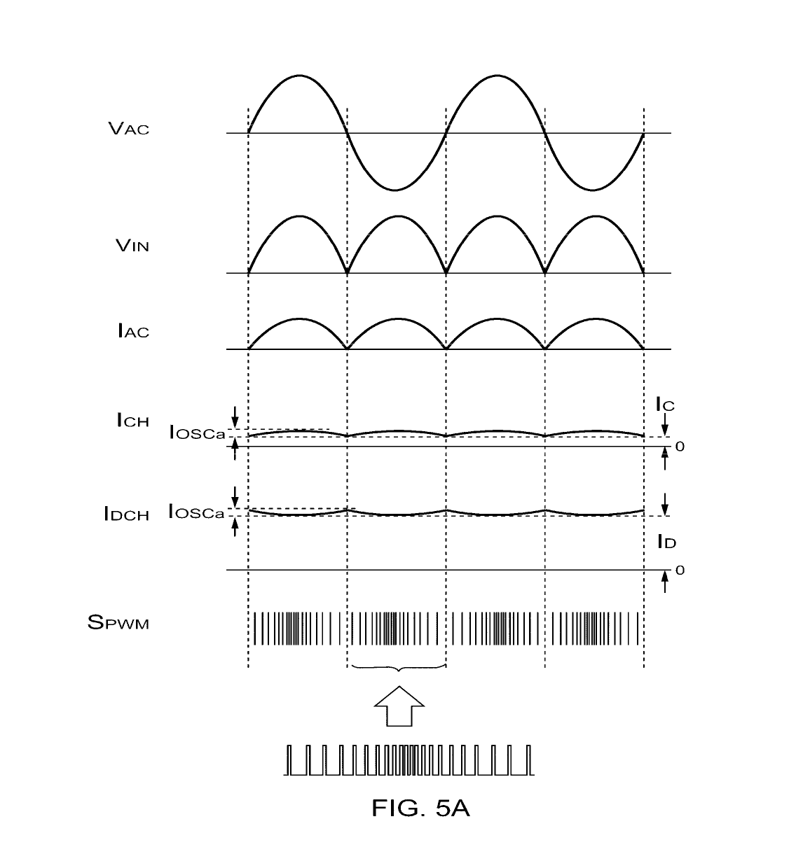

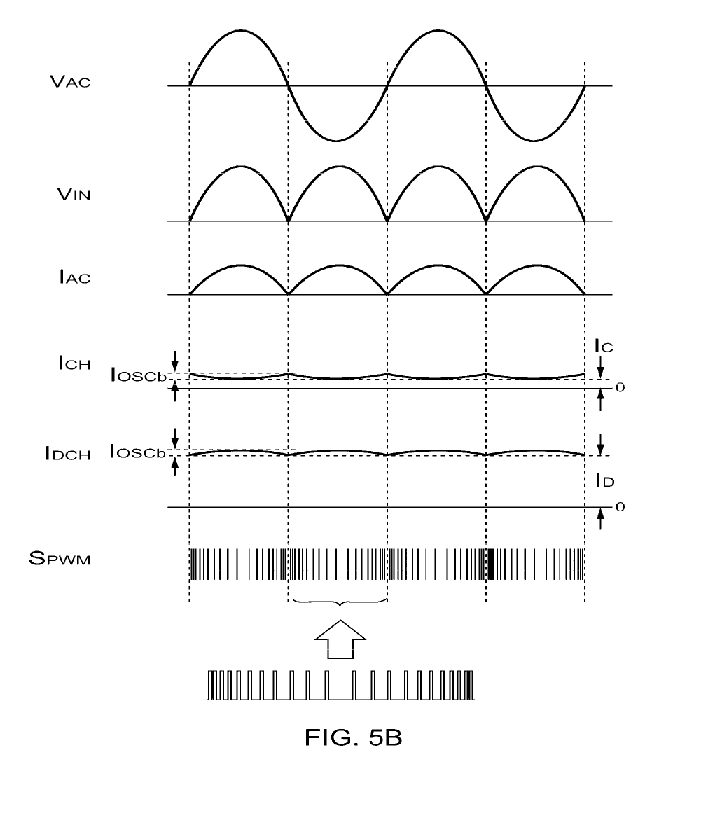

FIG. 5A shows key waveforms of the PFC power converter under the first jittering mode. Both referring to FIG. 3 and FIG. 5A, since the waveform of the oscillation current I_{OSCA} flows in the same direction as the charging current I_{CH}, the waveforms of them are both in direct proportion to the line signal I_{AC}. The discharging current I_{DCH} is in inverse proportion to the line signal I_{AC}. In response to the line signal I_{AC}, the amplitude of the charging current I_{CH} will fluctuate from the amplitude of the current I_{C} to the summed amplitude of the current I_{C} and the fluctuation amplitude I_{OSCa} of the oscillation current I_{OSCA}. Since the discharging current I_{DCH} flows in inverse direction to the oscillation current I_{OSCA}, an increased oscillation current I_{OSCA} will increase the charging current I_{CH} and decrease the discharging current I_{DCH}. Therefore, as the amplitude of the line signal I_{AC} increases, the charging current I_{CH} will increase while the discharging current I_{DCH} decreases. As shown in FIG. 5A, the fluctuation amplitude I_{OSCa} of the oscillation current I_{OSCA} is significant to the current I_{C} and is almost negligible to the current I_{D}. As a result, the frequency of the switching signal S_{PWM} will gradually increase as the amplitude of the line signal I_{AC} is increasing and vice versa.

FIG. 5B shows key waveforms of the PFC power converter under the second jittering mode. Both referring to FIG. 3 and FIG. 5A, since the waveform of the oscillation current I_{OSCB} flows in the same direction as the discharging current I_{DCH}, the waveforms of them are both in direct proportion to the line signal I_{AC}. The charging current I_{CH} is in inverse proportion to the line signal I_{AC}. In response to the line signal I_{AC}, the amplitude of the charging current I_{CH} will fluctuate from the amplitude of the current I_{C} to the summed amplitude of the current I_{C} and the fluctuation amplitude I_{OSCb} of the oscillation current I_{OSCB}. Since the charging current I_{CH} flows in inverse direction to the oscillation current I_{OSCB}, an increased oscillation current I_{OSCB} will decrease the charging current I_{CH} and increase the discharging current I_{DCH}. Therefore, as the amplitude of the line signal I_{AC} increases, the charging current I_{CH} will decrease and the discharging current I_{DCH} will increase. As shown in FIG. 5B, the fluctuation amplitude I_{OSCb} of the oscillation current I_{OSCB} is significant to the current I_{C} and is almost negligible to the current I_{D}. As a result, the frequency of the switching signal S_{PWM} will gradually decrease as the amplitude of the line signal I_{AC} is increasing and vice versa.

Two jittering modes are selectable by adjusting the first ratio and the second ratio of the current generation circuit to determine the first jittering current I_{JC} and the second jittering current I_{JD} for spreading a frequency spectrum of the frequency of the switching signal S_{PWM}. The present invention spreads the spectrum of the switching frequency by using the waveform of line signal obtained from an input of the power converter, which eliminates the need of an additional jittering signal generator and therefore simplifies the circuit design and saves the manufacturing cost.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A circuit of reducing electro-magnetic interference for a power converter, comprising:
an oscillator having a first terminal for receiving a first jittering current and a second terminal for feeding a second jittering current, wherein said first jittering current and said second jittering current are correlated with a line signal obtained from an input of said power converter to vary a frequency of said oscillator; and
a current generation circuit generating said first jittering current and said second jittering current in response to said line signal.

2. The circuit as claimed in claim 1 further comprising a feedback circuit, wherein said feedback circuit receives a feedback signal from an output of said power converter, and said feedback circuit generates an error signal.

3. The circuit as claimed in claim 2 further comprising a ramping generator, wherein said ramping generator generates a ramping signal to be compared with said error signal to disable a switching signal of said circuit.

4. The circuit as claimed in claim 3, wherein said ramping generator receives said switching signal to generate said ramping signal.

5. The circuit as claimed in claim 3, wherein as said first jittering current is set greater than said second jittering current, a frequency of said switching signal increases whenever said line signal is increasing.

6. The circuit as claimed in claim 3, wherein as said first jittering current is set lower than said second jittering current, a frequency of said switching signal decreases whenever said line signal is increasing.

7. The circuit as claimed in claim 1, wherein said first jittering current and said second jittering current are unequal.

8. A method of reducing electro-magnetic interference for a power converter, comprising the steps of:
generating a first jittering current in response to an line signal obtained from an input of said power converter with a first ratio;
generating a second jittering current in response to said line signal obtained from said input of said power converter with a second ratio; and
providing said first jittering current and said second jittering current to an oscillator of said power converter, wherein said oscillator determines a frequency of a switching signal for said power converter according to said first jittering current and said second jittering current.

9. The method as claimed in claim 8, wherein two jittering modes are selectable by determining said first ratio and said second ratio for spreading a frequency spectrum of a frequency of said switching signal.

10. The method as claimed in claim 8 further comprising:
receiving a feedback signal from an output of said power converter to generate an error signal; and
comparing a ramping signal from a ramping generator with said error signal to disable said switching signal.

11. The method as claimed in claim 10 further comprising:
receiving a pulse signal to enable said switching signal, wherein said pulse signal is generated from said oscillator.

12. The method as claimed in claim 10, wherein said ramping signal is generated in response to said switching signal.

13. The method as claimed in claim 8, wherein said first ratio and said second ratio are unequal.
